(19) United States
(12) Patent Application Publication
(10) Pub. No.: US 2008/0295318 A1
(43) Pub. Date: Dec. 4, 2008

(54) Method and Device for Continuously Producing Electronic Film Components and an Electronic Film Component

(76) Inventor: Martin Bohn, Reutlingen (DE)

Correspondence Address: K.F. ROSS P.C., 5683 RIVERDALE AVENUE, SUITE 203 BOX 900, BRONX, NY, 10471-0900, US

(21) Appl. No.: 10/588,345

(22) PCT Filed: Feb. 1, 2005
(86) PCT No.: PCT/EP2005/000951

§ 371 Date: Aug. 14, 2008

(30) Foreign Application Priority Data
Feb. 4, 2004 (DE) 10 2004 006 457.1

(51) Int. Cl. H01Q 17/00; B23P 19/00

(52) U.S. Cl. 29/601; 29/740

(57) ABSTRACT

The invention relates to a method and device for continuously producing electronic film components, during which chip modules (5) are, via their electrical connecting contacts (3), placed on antenna connections (2) of antenna film sections. The invention provides that: the chip modules (5), via their rear side facing away from the connecting contacts (3), are placed on adhesive film sections (7, 8) whose base area is significantly larger than a base area of each chip module; the electric connecting contacts of the chip modules are electrically contacted by antenna connections, and; the adhesive film sections (7, 8) are flatly joined to the antenna film sections in such a manner that the chip modules are fixed in their position relative to the antenna connections. The invention is for use in flexible transponder labels.

The invention relates to a method for continuously producing electronic film components in the form of transponders, chip modules via their electrical connecting contacts being placed on antenna connections of antenna film sections, to a method for continuously producing electronic film components in the form of chip module labels, to an apparatus for carrying out such a method with a chip module station on which the chip modules are stored as well as an adhesive film station on which the adhesive film sheet is fed in the form of a roll, and an electronic film component.

A method and an apparatus for continuously producing transponders are known from DE 101 20 269 C1. In the known method, chip modules are held on a support tape. An antenna film sheet is provided that comprises a plurality of antenna film sections arrayed in a row behind each other. Each antenna film section comprises antenna connections with which electrical terminals of the chip modules have to be connected. The chip modules are detached from the support tape and at the same time applied to the terminals of the antenna film sections and wound together with the antenna film section. The terminals of the chip modules are connected to the antenna connections by laser soldering.

Alternatively it is also possible to connect the terminals of the chip modules with the antenna connections by crimping. The soldering or crimping of the chip modules with the antenna film sections is carried out such that both the electrical connection and the fixed positioning of the chip modules relative to the antenna connections are achieved.

It is the object of the invention to create a method, an apparatus and an electronic film component of the kind mentioned above that with simple means ensure reliable function of the film components.

For the method for producing transponders, this object is achieved in that the chip modules with their backs facing away from the connecting contacts are applied to adhesive film sections, the base surface of which is substantially greater than a base surface of the chip module, that the electrical connecting contacts of the chip modules are electrically contacted with the antenna connections, and that the adhesive film sections are connected flat on the surfaces to the antenna film sections such that the chip modules are fixed in their positions relative to the antenna connections. As a result of the solution according to the invention, the chip modules are electrically contacted exclusively with the antenna connections without there having to be a separate fixing of the chip modules relative to the antenna film sections with this contacting. The fixation of the position of the chip modules relative to the antenna film sections is achieved with the adhesive film sections that are connected on the surfaces to the antenna film sections around the respective chip module and that fix the chip module in its position to the antenna connections. Consequently, the chip modules are fixed to the respective antenna film section by the adhesive film section. The chip modules themselves above all assume the function of electrical contacting with the antenna connections, without having it being necessary to also an independently fix their positions by this contacting. Electrical connections can be formed by the mechanical connection of conductive parts of the connecting contacts and the antenna connections or also through a conductive material connection such as soldering, conductive media, for example conductive adhesive, or the like. The adhesive film sheet or the corresponding adhesive film sections additionally provided compared to the related art not only create a reliably and uniformly fixed position of the chip modules, but at the same time also form a protective film for the chip module and for the electronic film component formed by the chip module and the corresponding antenna film section. The adhesive film sections are preferably adjusted to the antenna film sections in terms of their dimensions. Advantageously, the adhesive film sections are dimensioned such that in any case an antenna structure of the respective antenna film section is covered. Each chip module is electrically insulated between the two electrical connecting contacts, so that upon contacting the connecting contacts with the antenna connections no undesirable shorts can be created. This simplifies the production process for the antenna, since the turns of the antenna can be placed on one side (preferably in printed antennas). The antenna connections are also spaced from each other and electrically insulated in the intermediate space. A chip module comprises a microchip and a module bridge that forms the electrical connecting contacts of the chip module and with which the microchip is conductively connected. For the electrical contacting of the connecting contacts of the chip modules with the antenna connections, the connecting contacts are preferably provided with contact tips that are produced either s in advance on the module bridges in a separate operation or continuously directly during the method according to the invention. The antenna film sections are preferably formed in that antenna structures are imprinted on a film section, preferably a sheet of paper. Alternatively, the antenna structures can also be formed by etching away the corresponding coatings. The solution according to the invention is particularly suitable for producing transponders that are used as safety labels for packaging, as safety labels for labeling and/or tailoring products and the like. The adhesive film sheet forms a cover layer of the electronic film component.

For the method for producing chip module labels, the object is achieved with the characteristics according to claim 2. The chip module labels also represent flexible electronic film components, however that have no antenna structures of their own. The chip module labels are preferably applied in a separate, subsequent operation onto surfaces of packaging materials, antenna structures being imprinted on the surfaces or applied otherwise.

In one embodiment of the invention, the antenna film sections are part of an antenna film sheet, each antenna film section having an antenna structure that is applied to the antenna film sheet. The antenna structure is preferably imprinted. Alternatively, it can be created by etching.

In another embodiment of the invention, an adhesive film sheet that has an adhesive coating on one side is provided continuously with chip modules at uniform distances, and subsequently the adhesive film sheet is divided into individual adhesive film sections, each carrying a chip module. In a further embodiment, the division of the adhesive film sheet into individual adhesive film sections occurs before the electrical contacting of the chip modules with the antenna connections. In both cases, the adhesive film sections are conveyed continuously, synchronously with the antenna film sheet, such that the connecting contacts of the chip modules are at exactly the same level as the antenna connections of the antenna structures of the antenna film sections. This way, with continuous conveyance of the antenna film sheet, exact electrical contacting of the chip modules with the antenna is film section can take place. At the same time, or directly thereafter, the chip modules are fixed in place by pressing the adhesive film sections on the antenna film sections. The adhesive film sections are preferably provided with an adhesive coating that is glued to the surface to the antenna film sheet. Since the chip modules protrude slightly compared to the antenna film sections, each adhesive film section automatically stretches across the chip module and presses it against the antenna film sheet. The adhesive film sheet is preferably separated into the individual adhesive film sections already after the chip modules have been applied to the adhesive film sheet, however prior to contacting the chip modules with the antenna film sheet. To this end, preferably rotating cutting tools are provided that divide the adhesive film sheet into the individual adhesive film sections in a continuous process before the sections are connected to the antenna film sections of the antenna film sheet. Particularly with the method for producing the chip module labels, the adhesive film sheet may be provided with a punched structure that can be pulled off together with the protective film sheet after connecting the adhesive film section, sort of in a film-like punched grid.

In a further embodiment of the invention, the contact tips of the electrical connecting contacts of the chip modules are mechanically pressed into the electrically conductive antenna connections. The mechanical connection primarily serves to establish the electrical contacting of the chip modules with the antenna connections. The chip modules are fixed on the antenna film sheet—as described above—already by the adhesive film sections.

In a further embodiment of the invention, the adhesive film sheet and the protective film sheet are connected across the surfaces thereof and wound in a composite film sheet onto a roll, the composite film sheet is then wound off the roll, and the adhesive film sheet and the protective film sheet are pulled away from each other prior to applying the chip modules and fed to different sheet paths. The protective film sheet forms a support layer for the adhesive film sheet and protects the adhesive film sheet and the chip modules from damage. At the same time, the protective film sheet forms the non-adhesive protective layer for the adhesive film sheet so as to prevent contamination of the adhesive coating.

In a further embodiment of the invention, the chip modules that have been applied to the antenna film sections of the antenna film sheet by means of the adhesive film sections, are wound on a roll together with the antenna film sheet. This way, simple and reliable storage of the electronic film components can be achieved. It is preferred if the electrical/electronic functions of the film components are verified prior to rolling up the chip modules together with the antenna film sheet. This way it is possible to mark film components without functions or transponders with malfunctions in order to be able to sort them in a subsequent step.

In a further embodiment of the invention, the electrical connecting contacts of the chip modules and/or the antenna connections are provided with substantially pyramidal, hard and conductive particles that are oriented such that the tips of the pyramids point in the direction of the corresponding connection. This increases the quality of the electrical contacting, since due to the high pressure present at the tip of the pyramid during a contacting process the tip penetrates into the deforming material of the corresponding connecting partner, thus creating a conductive electrical connection.

In a further embodiment of the invention, prior to the electrical contacting of the electrical connecting contacts of the chip modules with the antenna connections and prior to connecting the adhesive film sections to the antenna film sections, an adhesive is applied to the antenna film sections that adhesive following the electrical contacting and the connection forms an adhesive coating, the minimal expansion of which is defined by the boundary surfaces between the chip modules and the antenna film sections and the maximal expansion is defined by the boundary surfaces between the adhesive film sections and the antenna film sections. This improves the adhesive force, thus resulting in a more secure fixing of the chip modules relative to the antenna connections.

In a further embodiment of the invention, following the electrical contacting of the electrical connecting contacts of the chip modules with the antenna connections and following the connection of the adhesive film sections to the antenna film sections, a support layer, particularly a silicone support layer, is applied to the antenna film sections, and/or a cover layer is applied to the adhesive film sections. This way, a film component can be reliably stored in a simple manner and it can be detached from the silicone support layer as needed and be glued, for example, to a packaging material.

For the apparatus for carrying out the method that is provided with a chip module station on which the chip modules are stored, the task underlying the invention is achieved in that an adhesive film station is provided, on which the adhesive film sheet is placed in roll form, and in that a transfer station is provided, on which the chip modules are applied with the backs thereof individually to the adhesive surface side of the adhesive film sheet, the distances of the chip modules during application on the adhesive film sheet being selected such that an adhesive film section surrounding the associated chip module has a considerably larger surface than the base surface of the respective chip module. Alternatively, either a protective film sheet is placed, preferably in roll form, on a connecting station or an antenna film sheet is placed on an antenna film station. The described solution ensures that the corresponding adhesive film section results in a securely fixed chip module on a protective film sheet (chip module label) or on the associated antenna film section (transponder) of the antenna film sheet. By feeding the adhesive film sheet and the antenna film sheet or the protective film sheet in roll form, it is possible to continuously pull off the sheets from the corresponding rolls. This allows continuous production of the film components. As a result, a large number of corresponding film components can be produced in a relatively short time, be it transponders with antenna structures or chip module labels without antenna structures.

The apparatus operates based on the roll-on-roll method and thus allows continuous processing of the individual parts of the film components. According to the invention, the adhesion, and consequently fixation, of the chip modules and the creation of the electrical conductivity between the chip modules and antenna structures are distributed to two different areas. The solution according to the invention is particularly suitable for producing labels with electronic functions, particularly with electronic security or identification functions.

In one embodiment of the invention, a contacting station is provided for the continuous mechanical contacting of the electrical connecting contacts of the chip modules to the antenna connections of antenna film sections of the antenna film sheet. On this contacting station, preferably existing contact tips of the connecting contacts of the chip modules are connected to the antenna connections of the antenna film sheet. The contacting station is intended for the electrical contacting of the chip modules with the antenna connections.

In a further embodiment of the invention, an adhesion station is provided, on which the adhesive film sections protruding beyond the chip modules are connected on the surfaces thereof to the antenna film sections with which the respective chip module is electrically contacted. It is preferred if the adhesion station and the contacting station are integrated in a common unit of the apparatus so as to be able to achieve the electrical contacting and the fixation of the chip modules substantially simultaneously.

In a further embodiment of the invention, the width of the adhesive film sheet is greater than a width of the adhesive film sections. This way it is possible to provide the adhesive film sheet with a punched structure and to remove a corresponding punching grid as a waste product after connecting the adhesive film sheet to the protective film sheet and thus achieve the desired pre-punched and separated adhesive film sections.

In a further embodiment of the invention, at least one monitoring station is provided that verifies the function of the transponders. Additionally it may advantageous to provide a marking station in order to be able to mark transponders on which malfunctions were discovered.

In a further embodiment of the invention, a connecting station is provided, on which the antenna film sheet, including the chip modules applied thereon and the adhesive film sections, are wound onto a roll. This composite roll forms a compact storage roll for the finished electronic film components.

In a further embodiment of the invention, the transfer station comprises a separating unit for separating the chip modules as well as a turning station for transferring the chip modules with the backs to the adhesive film sheet. This way, the chip modules are already placed in the position in which they subsequently have to be applied to the antenna film section.

In a further embodiment of the invention, a separating station is provided for separating the adhesive film sheet with the chip modules into separate adhesive film sections.

In a further embodiment of the invention, a gluing station is provided where an adhesive is applied to the antenna film sheet or the protective film sheet. It is advantageous if the gluing station is provided in front of the adhesion and contacting station viewed in the sheet conveying direction. Furthermore, it is advantageous if the gluing station controls the application of adhesive such that appropriate adhesive surfaces are only created in the areas of the chip modules on the antenna film sheet or the protective film sheet. This supports the self-adhesive properties of the film sheets and thus improves accurate positioning of the chip modules. The partial adhesive application saves adhesive material and prevents the disruptive gluing or contamination of areas that do not require any adhesive application.

In a further embodiment of the invention a support film station is provided, on which the support layer is fed in film form in the wound state.

In a further embodiment of the invention a cover film station is provided, on which the cover layer is fed in film form in the wound state.

In a further embodiment of the invention, a gluing station is provided, on which an adhesive is applied to the cover layer and/or the support layer.

The electronic film component according to the invention can be produced with the method according to the invention described above.

Additional characteristics and advantages of the present invention will be apparent from the claims and the following description of preferred embodiments of the invention that are illustrated in the drawings.

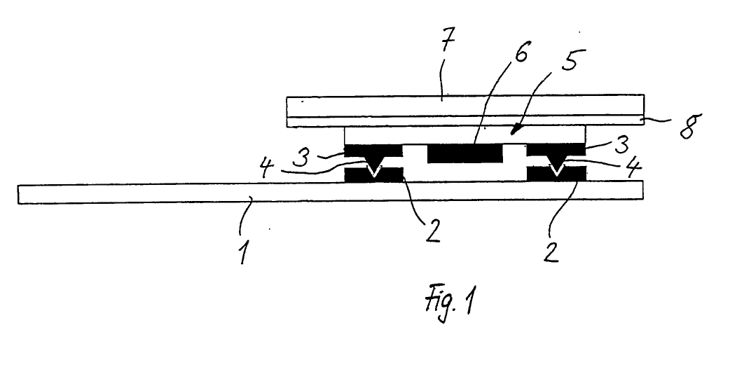

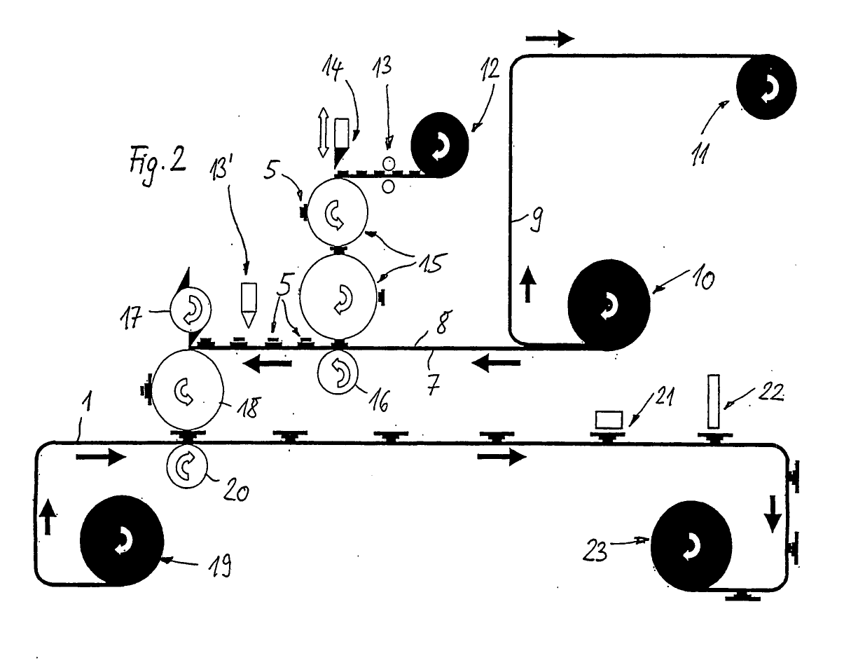

FIG. 1 shows a schematic, enlarged sectional view of an electronic film component in the form of a transponder that has been produced using an apparatus according to FIG. 2,

FIG. 2 is an embodiment of an apparatus for continuously producing electronic film components according to FIG. 1,

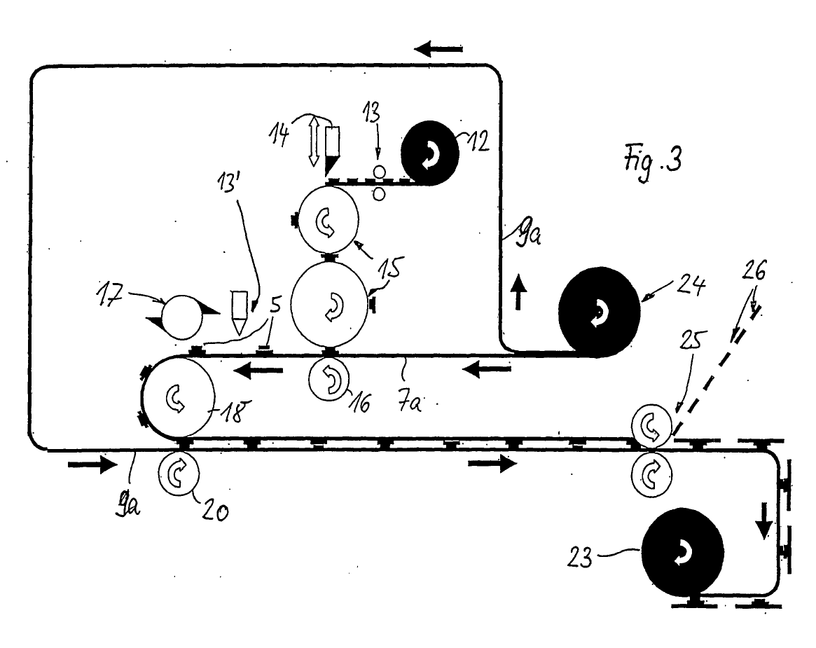

FIG. 3 is a further embodiment of an apparatus for continuously producing electronic film components without antenna structures according to FIG. 1,

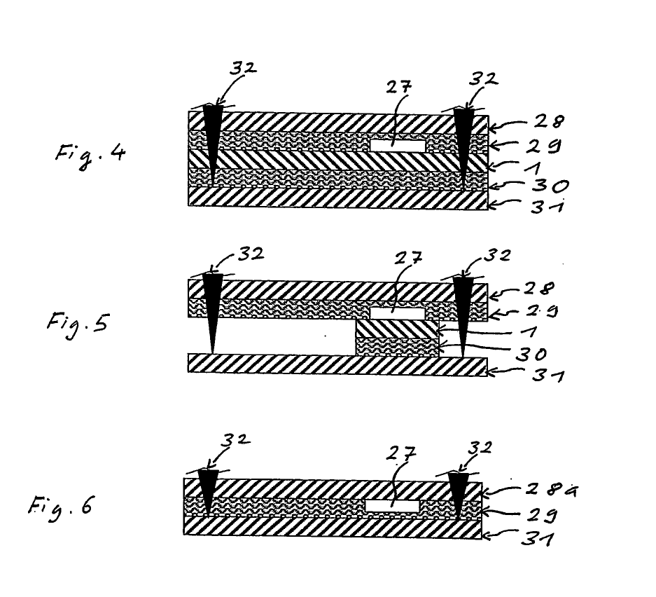

FIG. 4 shows a schematic, enlarged sectional view of a further electronic film component in the form of a transponder that has been produced using an apparatus according to FIG. 7,

FIG. 5 shows a schematic, enlarged sectional view of a further electronic film component in the form of a transponder,

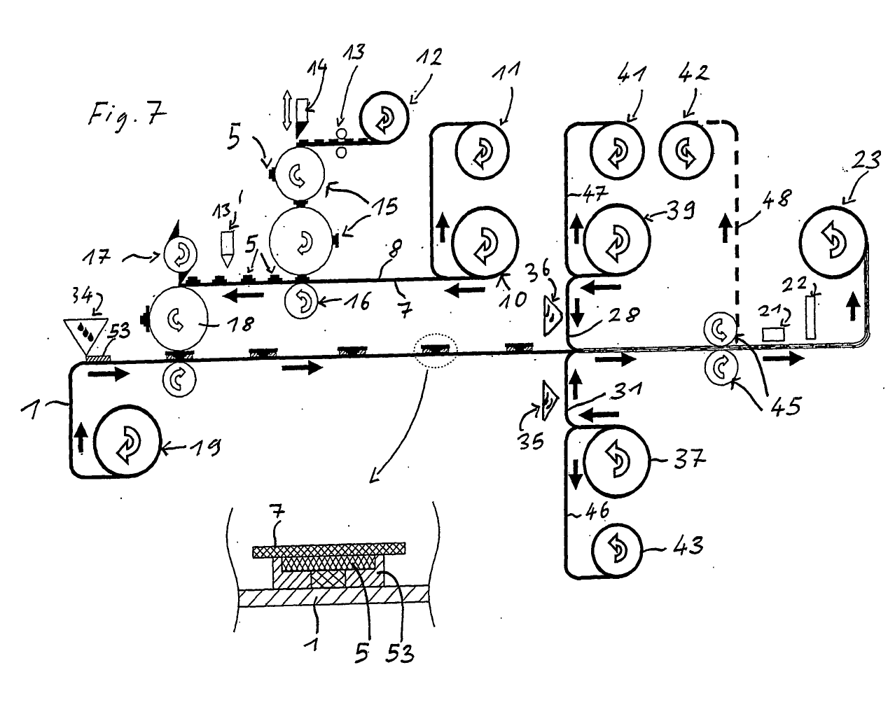

FIG. 6 shows a schematic, enlarged sectional view of a further electronic film component in the form of a transponder,

FIG. 7 is a further embodiment of an apparatus for continuously producing electronic film components according to FIG. 4,

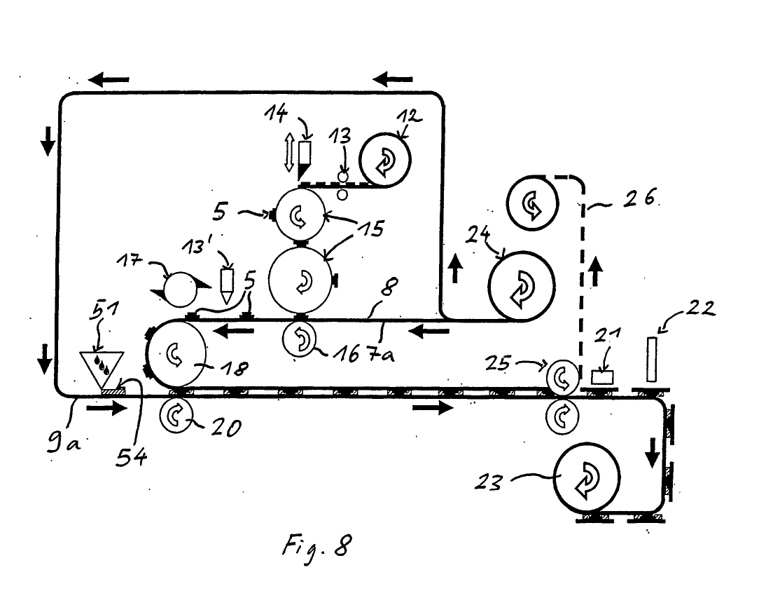

FIG. 8 is a further embodiment of an apparatus for continuously producing electronic film components without antenna structures according to FIG. 1,

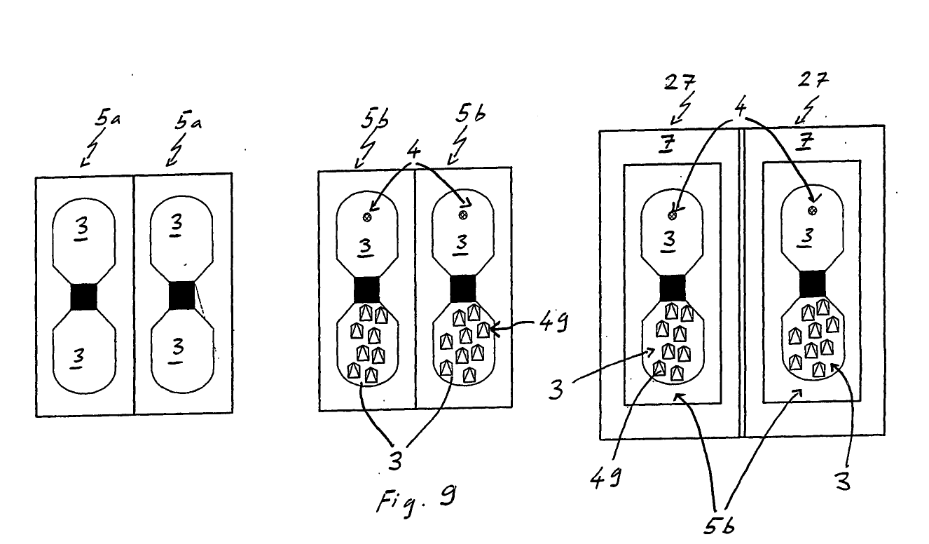

FIG. 9 shows top views of chip modules, whose connecting contacts have been processed, as well as adhesive film sections, to which the processed chip modules have been applied, and

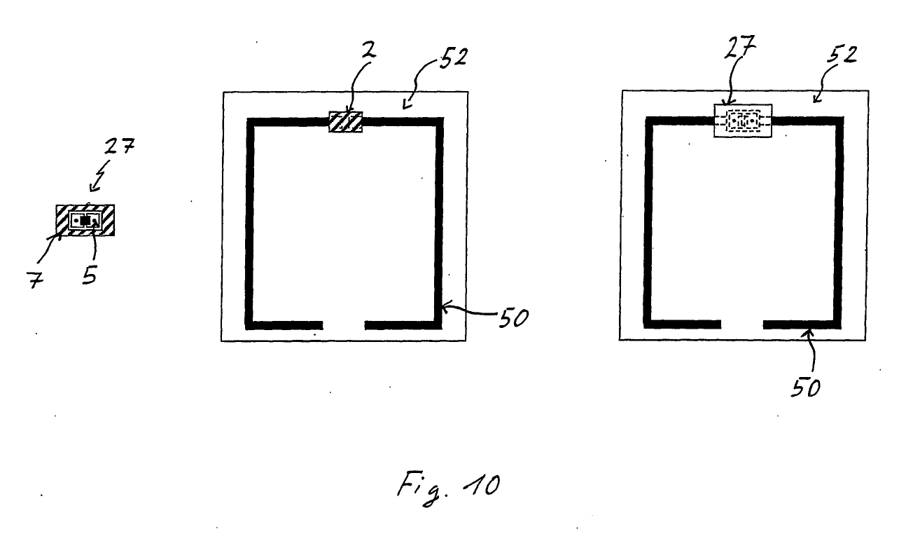

FIG. 10 shows an intermediate layer element, an antenna film section with an antenna as well as the intermediate layer element that has been applied to antenna connections.

FIG. 1 shows a drastically enlarged illustration of an electronic film component that is not to scale. Contrary to the impression that may arise from FIG. 1, the film component is not rigid or dimensionally stable, but rather it is flexible. According to FIG. 1, the film component is preferably a flexible film label that is configured as a transponder. To this end, an antenna structure that comprises two imprinted antenna connections 2 is imprinted on a lower support layer that represents an antenna film section of an antenna film sheet 1. As will be described in more detail hereinafter, the antenna film sheet comprises a plurality of antenna film sections arrayed in series that are associated with an antenna structure. The antenna film sections adjoin each other and can be separated by perforations. Alternatively, it is possible to separate the different antenna film sections with suitable cutting or punching tools upon completion of the film components. The perforations allow the antenna film sections to be severed without tools, thus separating the film components. As will be described in more detail hereinafter, the antenna film sheet 1 comprises a plurality of film components arrayed in series on the antenna film sheet 1 that components are all configured identically. For a simpler illustration, FIG. 1 therefore only shows one film component by way of example.

Each film component is provided with a chip module 5 that comprises an electronic semiconductor component 6 and a module bridge. The semiconductor component is preferably a microchip. The corresponding module bridge on the one hand serves to secure the microchip. On the other hand, it establishes the electrical connection to the microchip. For this purpose, the module bridge comprises electrical connecting contacts 3 on each side of the microchip 6 that is provided with contact pins or contact tips 4 that protrude downward to the antenna film sheet 1. The electrical connecting contacts 3 of the module bridge of the chip module 5 are positioned for the antenna connections 2 such that the connecting contacts 3 are positioned exactly above the antenna connections 2 and are electrically contacted with the antenna connections 2 when the contact tips 4 penetrate in the antenna connections 2. As a result of the electrical contacting of the module bridge with the antenna structure, the desired transponder is produced.

Each chip module 5 is held on an adhesive coating 8 of an adhesive film section 7. To this end, the back of each chip module 5 opposite the contact tip 4 is glued to the adhesive film section 7. The base surface of each adhesive film section 7 is substantially larger than the base surface of each chip module 5 so that the adhesive film section 7 overlaps the chip module 5 on the outside on all sides. Since also the overlapping region of the adhesive film section 7 on the inner face thereof facing the antenna film sheet 1 is provided on the entire surface with the adhesive coating 8, every adhesive film section 7 can be glued around the chip module 5 across the surface to the top of the antenna film sheet 1. This way, the chip module 5 is secured in its position on the antenna film sheet 1. At the same time, also the electrical contacting of the contact tips 4 with the antenna connections 2 is fixed. The chip module 5 as well as the imprinted antenna connections 2 of the antenna structures together have a height of less than 1 mm, so that the produced film label protrudes minimally even in the area of the chip module 5 or is minimally elevated in relation to the remaining label surface.

The adhesive coating 8 is preferably produced with a UV-curable adhesive. A preferred layer thickness measures 20 mm. The adhesive film sheet, and therefore also the adhesive film section 7, is preferably made of a polyethylene support film that preferably is transparent or opaque. A preferred layer thickness of the adhesive film sheet 7 is 50 mm. Each chip module preferably has an overall thickness of about 70 mm. The thickness of the antenna connections is about 30 mm. The thickness of the antenna film sheet 1 is about 70 mm. In a transition region of corresponding antenna structures, the module bridges of the chip modules 5 are preferably provided with an insulating layer in order to prevent short circuits of the antenna sheets.

The chip module may also be applied to a surface of a packaging item that surface has preferably been provided with an imprinted antenna structure. For this purpose, a chip module label is produced with the apparatus according to FIG. 3.

In order to produce the described electronic film components, according to FIG. 2 a machine is provided that operates continuously in the roll-on-roll method. The machine shown schematically in FIG. 2 is an apparatus for producing electronic film components as defined by the invention. The machine according to FIG. 2 has an adhesive film station 10 on which the adhesive film sheet 7 that is provided with the adhesive coating 8 on the inside, is wound on a roll. The adhesive coating 8 of the film sheet is also associated with a protective film sheet 9 that is formed by a silicone support film in the illustrated example. The adhesive film sheet 7 is wound off the roll such that the adhesive coating 8 is positioned on top. So as to expose the adhesive coating 8, the protective film sheet 9 is removed and wound onto a support roll 1.

The adhesive film sheet 7, together with the adhesive coating 8, travels through a transfer station 14, 15, 16, where the chip modules 5 are separated and applied to the adhesive coating 8 with the backs facing away from the contact tips 4. The transfer station 14, 15, on which the chain of chip modules 5 is separated and the individual chip modules are applied to the adhesive film sheet 7, 7a, comprises a turning station 15 with two deflection rollers rotating in opposite directions in addition to a separating apparatus 14. The chip modules 5 are wound onto a storage roll stringed together on a chip module station 12. When removing the chain of chip modules 5 formed this way, the connecting contacts 3 of each chip module 5 are provided with the contact tips 4 on a contact preparation station or an embossing station 13. Thereafter, the chip module chain is separated into individual modules on the separating station 14 that is preferably configured as a cutting tool. The individual chip modules 5 are first entrained by a deflection roller rotating counterclockwise according to the illustration in FIG. 2, the chip modules 5 adhering to the outer casing of the deflection roller. Then, the chip modules 5 are forwarded to a further deflection roller rotating in the opposition direction, i.e. clockwise, of the turning station 15 that is provided beneath the upper deflection roller. The transfer of each chip module 5 from the upper to the lower deflection roller is carried out in a tangential plane region between the two deflection rollers. The lower deflection roller is also provided on the outer circumference with adhesive means, preferably with vacuum bores of suctions means, in order to transport the chip modules 5 on the outer circumference in the circumferential direction. By transferring the chip modules 5 from the upper to the lower deflection roller, the chip modules 5 no longer rest with their backs, but instead with their fronts comprising the contact tips, on the outer casing of the lower deflection roller of the turning station 15. The circumferential speed of the lower deflection roller is adjusted to the conveyor speed of the adhesive film sheet 7 such that the chip modules 5 are applied to the adhesive film sheet 7 at uniform distances and are fixed on the adhesive coating 8. The turning station comprises beneath the adhesive film sheet 7 a support roller 16 that conveys the adhesive film sheet 7 in the removal direction and at the same time forms a counter-support for placing the chip modules 5 on the adhesive film sheet 7.

The adhesive film sheet 7 with the chip modules 7 is transported to a continuously operating separating apparatus that is configured as a rotating cutting tool 17.

Alternatively to the embossing station 13, it is possible to form the contact tips 4 of the electrical connecting contacts 3 of the chip modules 5 only after the chip modules 5 have been applied to the adhesive film sheet 7. For this purpose, the metering station 13′ is provided that carries out the corresponding production of the contact tips.

In both variations for producing the contact tips, the adhesive film sheet 7 with the chip modules 5 applied thereon is separated into several adhesive film sections, each carrying a chip module 5. These are deflected by means of a deflection roller 18 and applied to the antenna film sheet 1 on adhesion and contacting station 18, 20. The antenna film sheet 1 is maintained in the wound state on a storage roll on an antenna film station and is pulled off the storage roll 19 continuously. The antenna film sheet has a plurality of antenna film sections arrayed in series, of which each is associated with an antenna structure with antenna connections 2. As has been described above, the antenna structure is imprinted or alternatively etched on the antenna film sheet 1. The antenna structures are provided at uniform distances from each other on the antenna film sheet. The adhesive film sections as well as the chip modules 5 are applied on the contacting and adhesion station 18, 20 at uniform distances from each other continuously on the antenna film sections such that the contact tips of each chip module 5 meet exactly with the antenna connections 2 of each antenna structure. The adhesive film sections as well as the chip modules are pressed continuously on the steadily passing antenna film sheet 1, as a result of which the contact tips 4 cut wedge-like into the antenna connections 2 of the antenna structure while creating the corresponding electrical contact. This way, the transponders are produced. At the same time, the corresponding deflection and pressure rollers of the adhesion and contacting station 18, 20 that act on the adhesive film sections and the antenna film sheet 1 from both sides, are guided flexibly so that the adhesive film sections are pressed with the surfaces of the corresponding adhesive coatings 8 on the top side of each antenna film section as the chip modules are pushed in. The adhesive coating 8 then creates an areal adhesion of each adhesive film section to the associated antenna film section of the antenna film sheet 1 that secures the electrical contacting of the chip modules 5 with the antenna structures. The schematic illustration according to FIG. 2 does not show that the adhesive film sections are connected on the surfaces with the antenna film sheet after passing through the adhesion and contacting station 18, 20. The film components formed and produced this way are conveyed on the antenna film sheet 1 and pass through a monitoring station 21, in which the electrical and/or electronic functions of the transponder are inspected. Thereafter, the successive row or chain of transponders also passes through a marking station 22, where the film components are marked in terms of a potentially discovered malfunction, particularly by means of ink jet printing. Finally, the chain of film components is wound onto a storage roll of a connecting station 23 that roll is suitable for storage or for the further transport of the film components.

In the example according to FIG. 3, all units, components and sheets with identical functions have been assigned identical reference numerals as in FIG. 2. Only the functionally identical adhesive film sheet has additionally been assigned the letter “a”. A significant difference is that in this example self-adhesive chip module labels without transponder function, i.e. without antenna structures, are produced. These chip module labels are applied to surfaces, particularly to surfaces of packaging means, with corresponding antenna structures being provided only in a subsequent process that is not shown here.

In the embodiment according to FIG. 3, the protective film sheet is reused as a support layer for the produced chip module labels. The adhesive film sheet 7a and the protective film sheet 9a are wound in a self-adhesive configuration on a feed roll of a feeding station 24. So as to expose the adhesive coating 8 that is not described in detail, of the adhesive film sheet 7a, the protective film sheet 9a is removed directly after unwinding the feed roll of the feeding station 24, is then guided around the system above the chip module station and returned as the support layer in the area of the adhesion and contacting station 18, 20. The adhesion and contacting stations in this embodiment only serve the application of the chip modules to the protective film sheet 9a, without carrying out any additional electrical contacting function—due to the absence of an antenna film sheet. The turning station 15 that is used to apply the chip modules 5 to the adhesive film sheet 7a is configured identically to the embodiment according to FIG. 2, so that it does not need to be addressed in detail here. Another difference of the embodiment according to FIG. 3 is that the separating apparatus in the form of a rotating cutting tool 17 is disengaged in this embodiment. The adhesive film sheet 7a is not divided into individual adhesive film sections in front of the adhesion and contacting stations 18, 20. The adhesive film sheet 7a with the chip modules 5 applied thereon rather is maintained as a unit and is deflected around the corresponding deflection roller of the adhesion and contacting station 18, 20 such that the adhesive film sheet 7a is conveyed at the same belt speed as the protective film sheet 9a parallel in the same direction. The chip modules 5 are applied on the adhesive film sheet 7a at uniform distances from each other, so that later they can be removed as chip module labels from the protective film sheet that is configured as a silicone support film. Furthermore, the adhesive film sheet 7a of the protective film sheet 9a is guided in the area of the adhesion and contacting station 18, 20 such that the chip modules rest on the protective film sheet with their contact tips. At the same time, the entire adhesive film sheet 7a is glued around the around chip modules 5 onto the protective film sheet 9a, thus producing a composite film sheet. In the conveying direction, downstream of the adhesion and contacting station 18, a separating station 25 is provided that punches out the adhesive film sections of the adhesive film sheet 7a by means of rotating punching tool and removes the remaining waste punching grid 26 upward. The punching tool does not impede the protective film sheet 9a. As a result, the adhesive film sections with the chip modules remain on the protective film sheet 9a, the adhesive film sections having a width that is less than that of the adhesive film sheet 7a in order to achieve continuous, endless removal of the waste punching grid of the adhesive film sheet 7a. This produces the chip module labels removed in grids that labels are held on the protective film sheet. The finished film components (chip module labels), including the protective film sheet 9a, are wound onto a storage roll of the connecting station 23. The storage roll produced this way comprises a plurality of stringed film components in the form of the chip module labels without transponder functions.

FIG. 4 shows a considerably enlarged and not-to-scale sectional view of a further electronic film component in the form of a transponder that can be produced with an apparatus according to FIG. 7. The combination of chip module 5, adhesive 8 and adhesive film section 7 shown in FIG. 1 has been combined into an intermediate layer element 27. In the example according to FIG. 4, all further elements with identical functions have been assigned identical reference numerals as in FIG. 1. The intermediate element 27, as is shown in FIG. 1, is electrically contacted with the antenna connections 2 of an antenna of an antenna film section of the antenna film sheet 1 and fixed in its position relative to the antenna connections 2. Furthermore, unlike the film component shown in FIG. 1, a support layer 31 made of silicone and a cover layer 28 are provided that are connected in a material connection with the help of the adhesive coatings 29 and 30 to the top of the antenna film sheet 1 and the intermediate layer element 27 and/or a bottom of the antenna film sheet 1.

A punching tool 32 that is used to sever all layers except for the support layer 31 during a punching operation, is used to separate the different antenna film sections after completion of the film components. Following the punching operation, the film component can be pulled from the support layer 31, the adhesive coating 30 remaining on the removed component, thus making it self-adhesive, allowing it to be applied to a packaging material, for example.

FIG. 5 shows an alternative embodiment of an electronic film component in the form of a transponder that in comparison with the embodiment according to FIG. 4 has a shorter antenna film sheet 1 and/or a shorter antenna film section and, adjusted thereto, a shorter adhesive coating 30. Elements with identical functions have in turn been assigned identical reference numerals.

FIG. 6 shows a further alternative embodiment of an electronic film component in the form of a transponder that in comparison with the embodiments according to FIGS. 4 and 5 comprises two fewer layers. Elements with identical functions have in turn been assigned identical reference numerals. On a side of the cover layer 28a facing the intermediate layer element 27 of the cover layer 28a an antenna is provided that is not shown, but which is again in electrical contact with the intermediate layer element 27. By combining the antenna and cover layers, consequently 2 layers can be saved.

FIG. 7 is a further embodiment of an apparatus for continuously producing electronic film components according to FIG. 4, In addition to the apparatus according to FIG. 2, the apparatus comprises first to third gluing stations 34 to 36, a support film station 37 on which the sheet-like support layer 31 is fed in film form in the wound state, a cover film station 39 on which the sheet-like cover layer 28 is fed in film form in the wound state, collecting rollers 41 to 43 and a punching station 45. In the example according to FIG. 7, all further elements with identical functions have been assigned identical reference numerals as in FIG. 2.

Prior to the electrical contacting and prior to connecting the adhesive film sections 7 to the antenna film sections in the adhesion and contacting station 18, 20, the first gluing station 34 applies a adhesive 53 to the antenna film sections such that following the electrical contacting and the connection an adhesive coating forms between the adhesive film sections 7 and the chip modules 5 on the one hand and the antenna film sections or the antenna film sheet 1 on the other hand, the minimal expansion of which is defined by the boundary surfaces between the chip modules 5 and the antenna film sections and the maximal expansion of which is defined by the boundary surfaces between the adhesive film sections 7 and the antenna film sections. The adhesive is consequently not applied continuously, but is instead applied in cycles such that the desired local adhesive distribution is achieved. The application of adhesion effected by the first gluing station 34 supports the self-adhesive properties of the adhesive film sections 7, resulting in improved adhesion and thus a more secure fixation of the chip modules 5 relative to the antenna connections 2.

The support film station 37 is used to feed the sheet-like support layer 31 to the second gluing station 35, where it is provided with the adhesive coating 30 shown in FIG. 4. Thereafter, the support layer 31 with the adhesive coating 30 is connected to the bottom of the antenna film sheet 1, thus causing the adhesive coating 30 to create a material connection between the antenna film sheet 1 and the support layer 31. For the protection of the support layer 31, the layer is wound together with a protective film or a protective layer 46 in the support film station 37, with the film or layer being removed from the support layer 31 during the feeding process and rolled onto the collecting roller 43.

The cover film station 39 is used to feed the sheet-like cover layer 28 to the third gluing station 36, where it is provided with the adhesive coating 29 shown in FIG. 4. Subsequently, the cover layer 28 comprising the adhesive coating 29 is connected to the top of the antenna film sheet 1 and the intermediate layer element 27, a material connection being established by the adhesive coating 29. For the protection of the cover layer 28, the layer is wound together with a protective film or a protective layer 47 in the cover film station 39, with the film or layer being removed from the cover layer 28 during the feeding process and rolled onto the collecting roller 41.

The gluing stations 35 and 36 are optional. If the cover layer 28 and/or the support layer 31 are configured as self-adhesive coatings, the associated adhesive coating 29 and/or 30 that is protected by the protective film and/or protective layer 46 and/or 47, has already been placed on the cover layer 28 and/or the support layer 31 when it is wound on the associated film station 37 and/or 39. The additional application of adhesive by the gluing stations 35 and 36 is consequently no longer required in this case.

After both the support layer 31 and the cover layer 28 have been applied, the resulting layer composite is fed to the punching station 45 that separates all layers with the exception of the support layer 31 by means of the punching tool 32 shown according to FIG. 4. A resulting waste punching grid 48 is removed towards the top and wound on the collecting roll 42. The remaining layer composite, i.e. the finished film components and/or transponders, is wound on the storage roll of the connecting station 23 that is suitable for storage or further transport of the film components.

FIG. 8 is a further embodiment of an apparatus for continuously producing electronic film components without antenna structures. In addition to the apparatus according to FIG. 3, the apparatus comprises a gluing station 51. In the example according to FIG. 8, all further elements with identical functions have been assigned identical reference numerals as in FIG. 3. Prior to joining the adhesive film sheet 7a and the protective film sheet 9a in the area of the adhesion and contacting station 18, 20, the gluing station 51 is used to apply an adhesive 54 to the protective film sheet 9a such that an adhesive coating is produced in the area of the chip modules 5 are joining the sheets 7a and 9a. The adhesive is consequently not applied continuously, but is instead applied in cycles such that the desired local adhesive distribution is achieved. The application of adhesive effected by the gluing station 51 supports the self-adhesive properties of the protective film sheet 9a, thus improving adhesion.

FIG. 9 shows top views of unprocessed chip modules 5a, processed chip modules 5b whose connecting contacts 3 have been processed, as well as adhesive film sections 7, to which the processed chip modules 5b have been applied and/or glued. The unprocessed chip modules 5a are wound, for example, on the chip module station 12 according to FIG. 2 on the storage roll, stringed together.

The upper connecting contacts 3 of the chip modules 5b are provided by way of example with contact tips 4 that can be produced, for example, by the contact preparation station or embossing station 13 according to FIG. 2. The lower connecting contacts 3 of the chip modules 5b are alternatively provided with substantially pyramidal, hard and conductive particles 49 that are oriented such that the tips of the pyramids point in the direction of the corresponding connection, i.e. the antenna connection. A large bottom of a particle 49 ideally comes in contact with the connecting contact 3 across the entire surface. To simplify the illustration, only a few particles or pyramids 49 are shown for each connecting contact 3. In fact, however, many, for example several hundred particles 49 are provided for each connecting contact 3. The particles 49 can, for example, be made of nickel-coated diamond dust. The size of the particles typically ranges between 4 mm and 25 mm. If during a contacting operation on the bottom surface a slight pressure builds, a pressure increase results at the tip of the particle 49 that is proportional to the ratio of the surfaces. When the tip of the particle 49 pushes on the corresponding connection, the tip penetrates into the deforming material of the connecting partner and thus creates a conductive electrical connection. The particle 49 is typically already applied during the production of the chip modules 5.

FIG. 9 on the right shows adhesive film sections 7, to which the processed chip modules 5b have already been applied and/or glued. The chip modules 5b, an adhesive coating that is not shown, and the adhesive film sections 7 together form an intermediate layer element 27 according to FIG. 4. The intermediate layer element 27 formed this way can be connected considerably more easily to the antenna film sections than a chip module 5.

FIG. 10 shows top views of such an intermediate layer element 27, of an antenna film section 52 with an antenna 50 that comprises the antenna connections 2, as well as the intermediate layer element 27 that has been applied to the antenna connections 2 in a rotation in comparison with the illustration on the left. The connection of the intermediate layer element 27 and antenna film section 52 already represents a functional transponder that as is shown in FIG. 7 now only is given the support and cover layers.

So as to be able to carry out the methods according to the invention, as they are described according to FIGS. 1 to 3, automatically and continuously in the apparatus, a central controller is provided that controls the corresponding stations, tools and speeds of the conveying and deflection rollers. It is also conceivable to monitor the relevant physical variables of the individual functional and apparatuses, including the stations, tools, conveying and deflection rollers, through corresponding sensor units and to transmit corresponding signals or feedback messages to the controller, thus allowing control of the processing and manufacturing procedures of the film components.

1. A method for continuously producing electronic film components in the form of transponders, with chip modules (5) being applied with their electrical connecting contacts (3) to antenna connections (2) of antenna film sections of an antenna film sheet (1), characterized in that the chip modules (5) with their backs facing away from the connecting contacts (3) are applied to adhesive film sections (7, 8), the base surfaces of which are substantially greater than the base surface of each chip module (5), that the electrical connecting contacts (3) of the chip modules (5) are electrically contacted with the antenna connections (2), and that the adhesive film sections (7, 8) are connected on the surfaces to the antenna film sections (1) such that the chip modules (5) are fixed in position relative to the antenna connections (2).

2. A method for continuously producing electronic film components in the form of chip module labels, the chip modules being applied with their backs to adhesive film sections, the base surfaces of which are substantially larger than the base surface of each chip module, and electrical connecting contacts of the chip modules being provided with contact tips in order to bring them in a subsequent operation into an electrically conductive connection with the antenna connections of an antenna structure of an antenna film section, characterized in that at least one antenna film section is part of a surface of packaging.

3. The method according to claim 1, characterized in that an adhesive film sheet (7) that has been provided on one side with an adhesive coating (8) is provided continuously with the chip modules (5) at uniform distances and that subsequently the adhesive film sheet (7) is divided into individual adhesive film sections, each carrying a chip module (5).

4. The method according to claim 3, characterized in that the adhesive film sheet (7, 7a) is divided into individual adhesive film sections prior to the electrical contacting of the chip modules (5) with the antenna connections (2).

5. The method according to claim 1, characterized in that the contact tips of the electrical connecting contacts (3, 4) of the chip modules (5) are pressed mechanically into the electrically conductive antenna connections.

6. The method according to claim 4, characterized in that the adhesive film sheet (7, 7a) and a protective film sheet (9a) are connected on their surfaces and wound onto a roll in the form a composite film sheet, that the composite film sheet is wound off the roll, and that the adhesive film sheet (7a) and the protective film sheet (9a) are pulled away from each other before applying the chip modules (5) and fed to different sheet paths.

7. The method according to claim 1, characterized in that the chip modules (5) that have been applied to the antenna film sections of the antenna film sheet by means of the adhesive film sections, are wound onto a roll together with the antenna film sheet.

8. The method according to claim 2, characterized in that the chip modules applied to the adhesive film sheet are wound onto a roll together with the protective film sheet.

9. The method according to claim 7, characterized in that the electrical and/or electronic functions of the film components are inspected prior to winding the chip modules (5) together with the antenna film sheet (1).

10. The method according to claim 1, characterized in that the electrical connecting contacts (3) of the chip modules (5) and/or the antenna connections (2) are provided with substantially pyramidal, hard and conductive particles (49) that are oriented such that the tips of the pyramids point in the direction of the corresponding connection.

11. The method according to claim 1, characterized in that prior to the electrical contacting of the electrical connecting contacts (3) of the chip modules (5) with the antenna connections (2) and prior to connecting the adhesive film sections (7, 8) to the antenna film sections (1), an adhesive is applied to the antenna film sections (1) that adhesive following the electrical contacting and the connection forms an adhesive coating, the minimal expansion of which is defined by the boundary surfaces between the chip modules (5) and the antenna film sections (1) and the maximal expansion is defined by the boundary surfaces between the adhesive film sections (7, 8) and the antenna film sections (1).

12. The method according to claim 1, characterized in that following the electrical contacting of the electrical connecting contacts (3) of the chip modules (5) with the antenna connections (2) and following the connection of the adhesive film sections (7, 8) to the antenna film sections, a support layer (31), particularly a silicone support layer, is applied to the antenna film sections (1), and/or a cover layer (28) is applied to the adhesive film sections (7, 8).

13. An apparatus for carrying out the method according to claim 1, the apparatus comprising a chip module station (12) on which the chip modules (5) are stored, as well as an adhesive film station (10, 24) on which the adhesive film sheet (7, 7a) is placed in roll form, a transfer station (15) provided on which the chip modules (5) are applied with the backs thereof individually to the adhesive surface side (8) of the adhesive film sheet (7, 7a), and wherein the distances of the chip modules (5) during application on the adhesive film sheet are selected such that an adhesive film section surrounding the associated chip module (5) has a considerably larger surface than the base surface of the respective chip module (5).

14. The apparatus according to claim 13, characterized in that a contact preparation station (13, 13′) is provided, on which the electrical connecting contacts of the chip modules receive contact tips.

15. The apparatus according to claim 13, characterized in that an antenna film station (19) is provided, on which the antenna film sheet (1) is fed in the wound state.

16. The apparatus according to claim 13, characterized in that a contacting station (18, 20) is provided for continuously mechanically contacting the electrical connecting contacts of the chip modules (5) with antenna connections (2) of antenna film sections of the antenna film sheet (1).

17. The apparatus according to claim 16, characterized in that an adhesion station (18, 20) is provided, on which adhesive film sections protruding beyond the chip modules (5) are connected on the surfaces with the antenna film sections, with which the respective chip module (5) is electrically contacted.

18. The apparatus according to claim 13, characterized in that the width of the adhesive film sheet (7a) is greater than the width of the adhesive film sections.

19. The apparatus according to claim 13, characterized in that at least one monitoring station (21) is provided, on which the functions of the transponders are inspected.

20. The apparatus according to claim 13, characterized in that a connecting station (23) is provided, on which the antenna film sheet (1) as well as the chip modules (5) applied thereon and the adhesive film sections are wound onto a roll.

21. The apparatus according to claim 13, characterized in that the transfer station comprises a separating unit (14) for separating the chip modules (5) as well as a turning station (15) for transferring the chip modules (5) with the respective back sides to the adhesive film sheet.

22. The apparatus according to claim 13, characterized in that a separating station (25) is provided for separating the adhesive film sheet (7a) that is provided with the chip modules (5) into separate adhesive film sections.

23. The apparatus according to claim 13, characterized in that a gluing station (34, 51) is provided, on which an adhesive (53, 54) is applied to the antenna film sheet (1) or to the protective film sheet (9a).

24. The apparatus according to claim 23, characterized in that the gluing station (34, 51) is provided in front of the adhesion and contacting stations (18, 2) of the chip modules (5) viewed in the belt conveying direction.

25. The apparatus according to claim 24, characterized in that the gluing station controls the application of adhesive such that adhesive surfaces are produced only in the area of the chip modules (5) on the antenna film sheet (1) of the protective film sheet (9a).

26. The apparatus according to claim 13, characterized in that a support film station (37) is provided, on which the support layer (31) is fed in film form in the wound state.

27. The apparatus according to claim 13, characterized in that a cover film station (39) is provided, on which the cover layer (28) is fed in film form in the wound state.

28. The apparatus according to claim 26, characterized in that a gluing station (35, 36) is provided, on which an adhesive is applied to the cover layer and/or to the support layer.

29. An electronic film component, particularly in the form of a transponder that can be produced using the method according to claim 1.
